(19) United States
(12) Patent Application Publication
(10) Pub. No.: US 2005/0223830 A1
(43) Pub. Date: Oct. 13, 2005

(54) Structure of guide spring sheet for traverse

(75) Inventor: Hung-Jui Lin, Taipei (TW)

Correspondence Address: TROXELL LAW OFFICE LLC, SUITE 1404, 5205 LEESBURG PIKE, FALLS CHURCH, VA, 22041, US

(73) Assignee: EPO Science & Technology Inc.

(21) Appl. No.: 10/820,763

(22) Filed: Apr. 9, 2004

(51) Int. Cl. F16H 3/06

(52) U.S. Cl. 74/89.42

(57) ABSTRACT

A structure of a guide spring sheet for a traverse is used to combine to one side of a main body of a driving guide teeth for a traverse; it comprises a sheet body at the top end of an elastic sheet, bent to a direction and used for propping against the rear side of a teeth plate of the driving teeth body. A pressing sheet for propping against the top end of an elastic arm of the driving teeth plate at the top end of the elastic sheet is disposed at least one of the two sides of the top end of the sheet body; it allows the guide teeth to be engaged in the grooves of threads more stably and steadily. Whereby, a read/write lens is more stable and smooth while moving to and fro and the dislocation of the guide teeth can be less happened.

### BACKGROUND OF THE INVENTION

1. Field of the Invention

The present invention relates to a driving mechanism of an optical read/write head in a disk drive, and more particularly to a structure of a guide spring sheet in the driving mechanism.

2. Description of Related Art

Taiwan patent NO. 476,437 granted to the applicant of the present invention discloses:
driving guide teeth comprises a main body connected to an elastic arm. One end of the elastic arm has teeth for being engaged in threads of a lead screw, it is characterized in that a bent portion is disposed in the elastic arm to increases the length of the elastic arm so as to allow it to have a larger deformation and not to be broken easily, the design of the matching of elastic forces to be easier, production tolerances to be larger and a production cost to be lower.

The patent mentioned above is applied in the design of a traverse (mechanism) at the present. As FIG. 1 shows, a chassis 1 is connected to a motor 2 for driving a gear train 3, a lead screw 4, on which threads 41 are disposed, is driven by the gear train 3 to rotate. Two guide bars 52 and 53 are respectively engaged at the two sides of a pick-up head body 51 of an optical read/write lens 5 and driving guide teeth 10 are connected closely to one side of the guide bar 52. The driving guide teeth 10 are engaged in the threads 41 of the lead screw 4. When the lead screw 4 is rotated clockwise or counterclockwise, the driving guide teeth 10 can be driven to move to and fro so as to allow the read/write lens 5 to be moved to and fro.

Please refer to FIGS. 2 and 3. The driving guide teeth 10 comprises a main body 11 extended with two elastic arms 12. A bent portion 121 bent reversely is disposed at the end part of the two elastic arms 12. A teeth plate 13 with protruding guide teeth 131 is connected to the front of the bent portion 121. The guide teeth 131 can be engaged in the threads 41 on the lead screw 4 shown in FIG. 1. A guide spring sheet 14 made from metal. A sheet body 141 bent downward at one end of the guide spring sheet 14 is installed between the two elastic arms 12 to prop against the rear side of the teeth plate 13 and a hole 142 is opened at the top end thereof. A hole 110 is also opened at the top end of the main body 11. A screw 15 is screwed through the holes 142 and 110 in a sequence to combine the guide spring sheet 14 and the main body 11 with the pick-up head body 51 shown in FIG. 1 at one side thereof to allow the bottom end of the sheet body 141 to be propped against the rear side of the teeth plate 13 and the guide teeth 131 to be engaged in the grooves in the threads 41 shown in FIG. 1. The sheet body 141 is used to prop against the rear side of the teeth plate 13 to allow the teeth plate 13 to have a stronger resisting force so as to prevent the guide teeth 131 from being contracted backward to separate from the threads 41 to cause a teeth dislocation.

Putting the driving guide teeth into practice, when the guide teeth 131 are moved to the two ends of the lead screw 4 and is stopped moving there, Under an abnormal condition, the motor 2 still keeps driving the lead screw 4 to rotate, the walls of the grooves of the threads 41 will thrust the guide teeth 131 to move backward as well as upward. Although increasing the coefficient of elasticity of the sheet body 141 can rather stop the guide teeth 131 moving backward, it cannot stop the guide teeth 131 moving upward; a teeth dislocation can still happens. For further improving the structure of the driving guide teeth 131 and preventing the guide teeth from being dislocated, the prevent invention is proposed.

### SUMMARY OF THE INVENTION

The main object of the present invention is to provide a structure of a guide spring sheet for a traverse, used for withstanding a teeth plate to move upward to prevent guide teeth from being dislocated.

Another object of the present invention is to provide a structure of a guide spring sheet for a traverse, utilizing a current existing guide spring sheet to do a little improvement thereon, a better pressing effect can then be obtained so that a production cost is only increased little.

Still another object of the present invention is to provide a structure of a guide spring sheet for a traverse, enabling guide teeth to be engaged in grooves on threads more stably and steadily so as to allow an optical read/write head to move to and fro more stably and smoothly.

### BRIEF DESCRIPTION OF THE DRAWINGS

The present invention can be more fully understood by reference to the following description and accompanying drawings, in which:

FIG. 1 is a schematic view, showing a combination of a conventional guide spring sheet and a traverse;

FIG. 2 is an explosive view, showing a combination of a conventional guide spring sheet and a guide teeth main body;

FIG. 3 is a prospective view, showing a combination of a conventional guide spring sheet and a guide teeth main body.

FIG. 4 is an explosive view, showing a combination of a guide spring sheet for a traverse according to the present invention and a guide teeth main body.

FIG. 5 is a prospective view, showing a combination of a guide spring sheet for a traverse according to the present invention and a guide teeth main body.

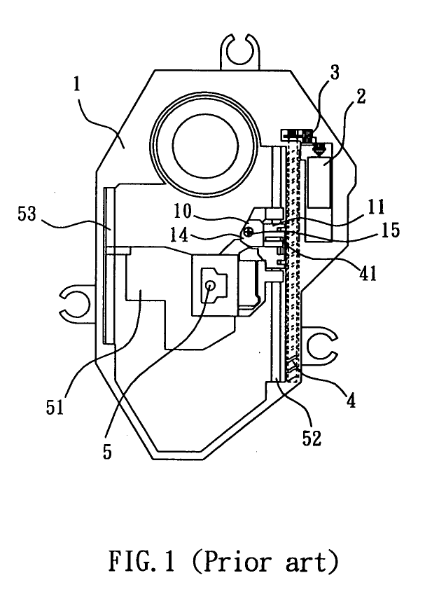

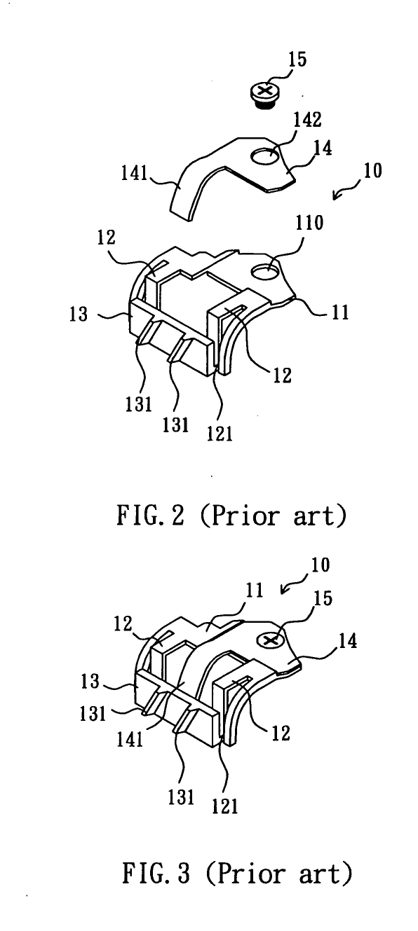

### DETAILED DESCRIPTION OF THE PREFERRED EMBODIMENTS

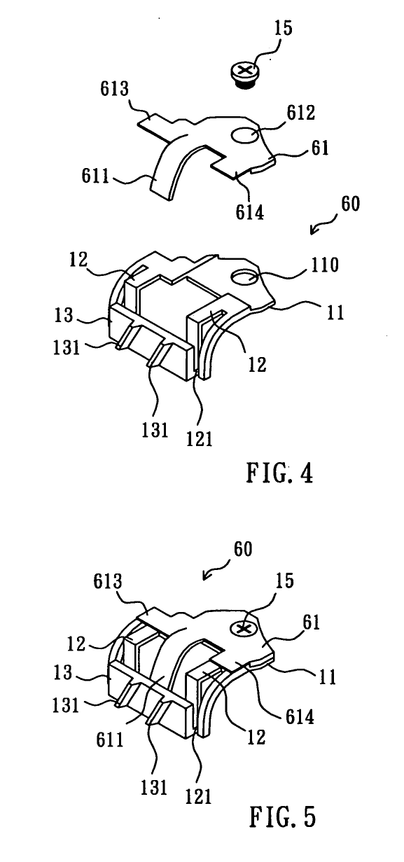

Please refer to FIGS. 4 and 5. The present invention is used to improve a guide spring sheet for driving guide teeth 60. The guide spring sheet comprises a sheet body 611 at the top end of an elastic sheet 61. The elastic sheet 61 is allowed to have not only a sheet body 611 bent downward but also pressing sheets 613 and 614 at the top end thereof disposed respectively at the two sides of the top end of the sheet body 611. When the screw 15 is screwed through a hole 612 in the elastic sheet 61 and a hole 110 in the main body 11 to combine the elastic sheet 61 and the main body 11 with the pick-up head body 51 of the read/write lens 5 at one side thereof. The pressing sheets 613 and 614 are respectively propped against the top ends of the two elastic arms 12. The two elastic arms 12 are rather not moved upward so as to cause the teeth plate 13 and the guide teeth 131 also to be moved less upward by pressing the upper sides of the top ends of the two elastic arms 12 with the two pressing sheets 613 and 614 when the bottoms of the two elastic arms 12 are acted by a upward thrust force from the teeth plate 13. Whereby, the gap between each guide tooth 131 and each corresponding engaged groove on the thread is allowed to be smaller so that a stable engagement of the teeth and the threads can be maintained and a smooth movement can be processed. Furthermore, the optical read/write head is allowed to move to and fro more stably and smoothly. The pressing sheets 613 and 614 at the two sides of the top end of the elastic sheet 61 according to the present invention can also be matched up with the rotation type of the thread by disposing the pressing sheet 613 or 614 at only one of the two sides; it can also attain the effect holding down the upper side of the top portion of the two elastic arms 12.

When the driving guide teeth are moved to the two ends of the lead screw, if they are stopped moving, the guide teeth are acted with backward and upward moving forces by the grooves of the threads when the motor is kept rotating. In the meantime, the rear side of the teeth plate bears a blocking force from the sheet body and the upper side thereof bears a blocking force from the two elastic arms so that the lead screw is further suppressed to exceed the load ability of the rotation of the motor to cause the motor to be stopped rotating and the guide teeth not to be separated from the grooves of the threads. Whereby, the teeth dislocation can be prevented.

The guide spring sheet according to the present invention can allow a motor with a higher power to be used and the teeth dislocation still not to be happened. The optical read/write lens can be allowed to move more smoothly and stably because the motor with a high power can be used.

It is noted that the structure of a guide spring sheet for a traverse described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

1. A structure of a guide spring sheet for a traverse, used to connect to one side of a main body of driving guide teeth for a traverse, comprising a sheet body bent at one direction disposed at the top end of a elastic sheet and used to prop against the rear side of a teeth plate of said main body; a pressing sheet at the top end of said elastic sheet being disposed at one side of the top end of said sheet body for being propped against the top end of a elastic arm of said main body.

2. The structure according to claim 1, wherein a pressing sheet is disposed at another side of the top end of said sheet body for being propped against the top end of another elastic arm of the said main body.

3. The structure according to claim 1, wherein a hole for being engaged with a screw is disposed at the top end of said elastic sheet.
